(19) United States
(12) Patent Application Publication
(10) Pub. No.: US 2023/0238817 A1
(43) Pub. Date: Jul. 27, 2023

(54) POWER TOOL AND METHOD OF CONTROLLING THE SAME

(71) Applicant: MOBILETRON ELECTRONICS CO., LTD., Taichung City (TW)

(72) Inventors: SHIH-HAO WANG, Tainan City (TW); KE-FENG LIN, Taichung City (TW)

(73) Assignee: MOBILETRON ELECTRONICS CO., LTD., Taichung City (TW)

(21) Appl. No.: 18/093,740

(22) Filed: Jan. 5, 2023

(30) Foreign Application Priority Data
Jan. 21, 2022 (TW) 111102697

(51) Int. Cl. H02J 7/00; B25F 5/00; H01M 10/44

(52) U.S. Cl. CPC H02J 7/0063; B25F 5/00; H02J 7/0013; H01M 10/441

(57) ABSTRACT

A power tool includes a first connecting port, a second connecting port, a motor module, a first switching member, a second switching member, and a control device. The first switching member is connected between the motor module and the first connecting port. The second switching member is connected between the motor module and the second connecting port. The control device is connected to the first switching member and the second switching member. A control method thereof includes: switch on the first switching member and the second switching member when the control device determines that both the first connecting port and the second connecting port are respectively connected to a battery and a difference between voltages inputted to the first connecting port and the second connecting port is smaller than a predetermined voltage difference, allowing two batteries to supply power to the motor module at the same time.

### BACKGROUND OF THE INVENTION

### Technical Field

The present invention relates generally to a power tool, and more particularly to a power tool powered by a dual battery system.

### Description of Related Art

In a power tool powered by a dual battery system, two batteries B are connected in parallel to supply power to a motor M as the power for the operation of the motor M, Referring to FIG. 1, a conventional power tool powered by a dual battery system includes two batteries B connected in parallel, two diodes D, and a motor M, wherein each of the diodes D is connected between one of the batteries B and the motor M, thereby a power of each of the batteries B outputs to the motor M through one of the diodes D. With the characteristic of each of the diodes D in the reverse biased (i.e., the diode D is cut off in the reverse biased), the problem that one of the batteries B with the higher voltage overcharges the other one of the batteries B with the lower voltage when the voltage difference between the two batteries is too large can be effectively prevented, however, the battery B needs to overcome a forward bias of the diode D to make the diode D conduct, which will cause a loss of power in one of the batteries B. In addition, when the motor M is in the process of actuating for a long time and outputs high power, the diode D is easily overheated and damaged.

Moreover, a counter electromotive force generated when the motor M stops running cannot be recharged to the battery B due to the diode D being cut off in the reverse biased, thereby generating a heat energy, which may cause the motor M overheat.

In all aspects, the power tool powered by the dual battery system still has room for improvement.

### BRIEF SUMMARY OF THE INVENTION

In view of the above, the primary objective of the present invention is to provide a power tool, which could not only reduce a power loss of each of two batteries but also avoid the problem that the battery with a higher voltage overcharges the battery with a lower voltage when a voltage difference between the two batteries is too large.

The another objective of the present invention is to provide a power tool, which could provide a path for back electromotive force discharge.

The present invention provides a power tool including a first connecting port, a second connecting port, and a motor module and characterized in that the power tool includes a first switching member, a second switching member, and a control device. The first switching member has a first end, a second end, and a first control end, wherein the first end is electrically connected to the first connecting port, the second end is electrically connected to the motor module, and the first control end is controllable to conduct or cut off the first end and the second end. The second switching member has a third end, a fourth end, and a second control end, wherein the third end is electrically connected to the second connecting port, the fourth end is electrically connected to the motor module, and the second control end is controllable to conduct or cut off the third end and the fourth end. The control device is electrically connected to the first connecting port, the second connecting port, the first control end of the first switching member, and, the second control end of the second switching member, wherein when the control device determines that the first connecting port is connected to a battery and the second connecting port is connected to a battery, the control device detects a first voltage inputted to the first connecting port and a second voltage inputted to the second connecting port. When a difference between the first voltage and the second voltage is smaller than a predetermined voltage difference, the control device outputs a first control signal to the first control end and outputs a second control signal to the second control end, thereby building a conduction between the first end and the second end and building a conduction between the third end and the fourth end, allowing both a power of the battery connected to the first connecting port and a power of the battery connected to the second connecting port to supply to the motor module.

The present invention further provides a method of controlling the power tool, including following steps.

take following steps when the control device determines that the first connecting port is connected to a battery and the second connecting port is connected to a battery;

A1. detect a first voltage inputted to the first connecting port and a second voltage inputted to the second connecting port through the control device;

A2. output a first control signal to the first control end and output a second control signal to the second control end through the control device when the control device determines that a difference between the first voltage and the second voltage is smaller than a predetermined voltage difference, thereby building a conduction between the first end and the second end and building a conduction between the third end and the fourth end, allowing both a power of the battery connected to the first connecting port and a power of the battery connected to the second connecting port to be supplied to the motor module.

With the aforementioned design, the loss of the power of the battery could be reduced by the conduction of the switching members. In addition, the first switching member and the second switching member are switched on only when the first connecting port is connected to the battery and the second connecting port is connected to the battery and the difference between the two batteries is smaller than the predetermined voltage difference, which could effectively avoid the problem that the battery with a higher voltage overcharges the battery with a lower voltage when a voltage difference between the two batteries is too large. Moreover, the back electromotive force generated by the motor module could be transmitted to the batteries through the first switching member and the second switching member, thereby providing a path for the back electromotive force discharge.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a block diagram of the conventional power tool;

FIG. 2 is a block diagram of the power tool according to a first embodiment of the present invention;

FIG. 3 is a flowchart of the method of controlling the power tool according to the first embodiment of the present invention;

FIG. 4 is a flowchart of the method of controlling the power tool according to a second embodiment of the present invention;

FIG. 5 is a block diagram of the power tool according to a third embodiment of the present invention;

FIG. 6 is a flowchart of the method of controlling the power tool according to the third embodiment of the present invention;

FIG. 7 is a block diagram of the power tool according to a fourth embodiment of the present invention; and

FIG. 8 is a flowchart of the method of controlling the power tool according to the fourth embodiment of the present invention.

### DETAILED DESCRIPTION OF THE INVENTION

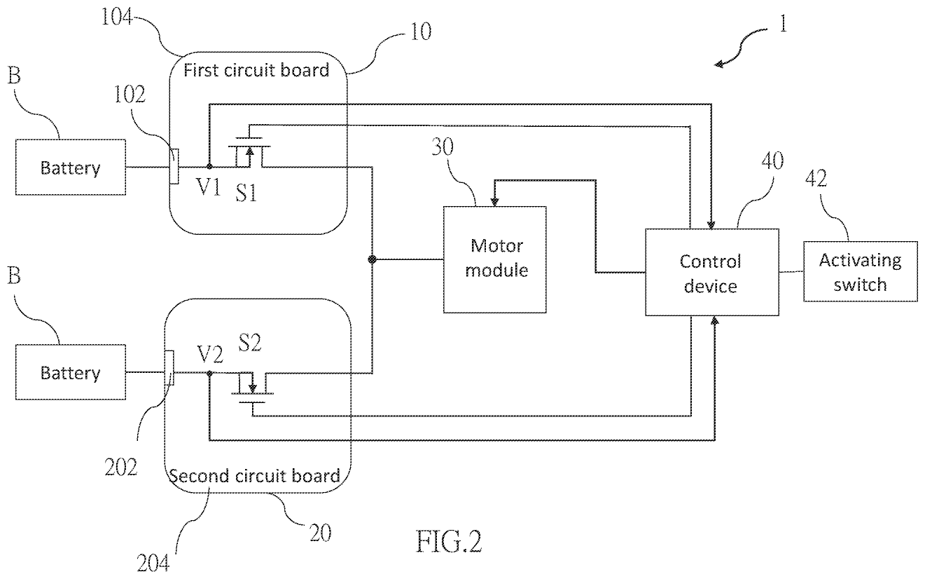

A power tool 1 according to a first embodiment of the present invention is illustrated in FIG. 2 and includes a first connecting port 102, a second connecting port 202, a first switching member S1, a second switching member S2, a motor module 30, and a control device 40.

The first connecting port 102 and the first switching member S1 are disposed on a first circuit board 104, wherein the first connecting port 102, the first switching member S1, and the first circuit board 104 form a first power switching module 10, wherein the first connecting port 102 could be selectively connected to a battery B. The first switching member S1 has a first end, a second end, and a first control end, wherein the first end is electrically connected to the first connecting port 102, and the second end is electrically connected to the motor module 30, wherein the first control end is controllable by receiving a first control signal to conduct the first end and the second end, while the first end and the second end cut off when the first control end does not receive the first control signal.

The second connecting port 202 and the second switching member S2 are disposed on a second circuit board 204, and the second connecting port 202, the second switching member S2, and the second circuit board 204 form a first power switching module 20, wherein the second connecting port 202 could be selectively connected to a battery B. The second switching member S2 has a third end, a fourth end, and a second control end, wherein the third end is electrically connected to the second connecting port 202, the fourth end is electrically connected to the motor module 30, and the second control end is controllable by receiving a second control signal to conduct the third end and the fourth end, while the third end and the fourth end cut off when the first control end does not receive the second control signal.

In the current embodiment, the first switching member S1 and the second switching member S2 are respectively an electronic switch, which is a MOSFET as an example. However, the first switching member S1 and the second switching member S2 are not limited to the MOSFET, but could be a BJT. The first end of the first switching member S1 and the third end of the second switching member S2 are respectively a drain, the second end and the fourth end are respectively a source, and the first control end and the second control end are respectively a gate. In other embodiments, the switching members (i.e., the first switching member S1 and the second switching member S2) could be a mechanical switch respectively (e.g. a relay). The first power switching module 10 and the first power switching module 20 could form a modular design, which facilitates the assembly of the power tool 1.

The motor module 30 at least includes a motor connected to a transmission mechanism (not shown). When the motor runs, the transmission mechanism could be driven to turn to drive an external tool. In the current embodiment, the motor is a brushless DC motor, and the motor module 30 further includes a driving circuit board (not shown) for driving the motor to turn.

The control device 40 is electrically connected to the first connecting port 102, the second connecting port 202, the first control end of the first switching member S1, and the second control end of the second switching member S2. The control device 40 is adapted to detect whether the first connecting port 102 is connected to the battery B and whether the second connecting port 202 is connected to the battery B, and output the first con it signal and the second control signal to the first switching member S1 and the second switching member S2. In the current embodiment, the control device 40 is connected to an activating switch 42 and is electrically connected to the motor module 30. When the control device 40 outputs the first control signal or the second control signal to the first switching member S1 or the second switching member S2, a power is supplied to the motor module 30. When the activating switch 42 is pressed, the control device 40 controls the motor module 30 to drive the transmission mechanism, In the current embodiment, the control device 40 includes a Micro Controller Unit (MCU), wherein a first voltage V1 inputted to the first connecting port 102 via the two batteries B and a second voltage V2 inputted to the second connecting port 202 via the two batteries B could be stepped down by a voltage dividing circuit to be inputted to the MCU. The MCU executes a control program to perform a control method of the current embodiment.

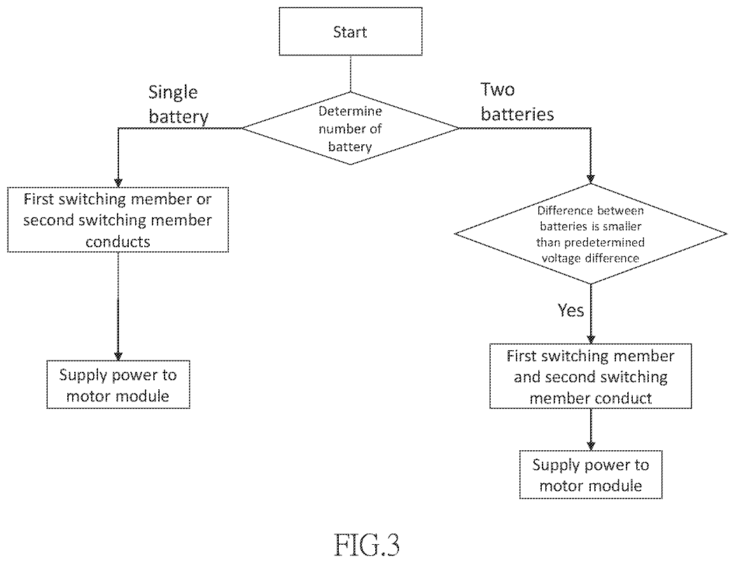

With the aforementioned design, the control method of the current embodiment could be applied, wherein the control method includes following steps shown in FIG. 3.

First, the control device 40 determines whether the battery B installed in the power tool 1 is a single battery or two batteries. In the current embodiment, the control device 40 determines whether the first connecting port 102 and the second connecting port 202 are respectively connected to the battery B by detecting whether there is a voltage inputted to the first connecting port 102 and the second connecting port 202 respectively. In other words, when the control device 40 detects that the first connecting port 102 has the first voltage V1, the control device 40 determines that the first connecting port 102 is connected to the battery B; when the control device 40 detects that the second connecting port 202 has the second voltage V2, the control device 40 determines that the second connecting port 202 is connected to the battery B.

A dual battery mode is executed when the control device 40 determines that both the first connecting port 102 and the second connecting port 202 are connected to the batteries B, while a single battery mode is executed when the control device 40 determines that either the first connecting port 102 or the second connecting port 202 is connected to the battery B.

### Dual Battery Mode

The control device 40 further detects the first voltage V1 and the second voltage V2 and determines whether a difference between the first voltage V1 and the second voltage V2 is smaller than or equal to a predetermined voltage difference, wherein when the difference between the first voltage V1 and the second voltage V2 is smaller than or equal to the predetermined voltage difference, the control device 40 outputs the first control signal to the first control end of the first switching member S1 and outputs the second control signal to the second control end of the second switching member S2, allowing the two switching members to switch on (i.e., a conduction between the first end and the second end of the first switching member S1 is built, and a conduction between the third end and the fourth end of the second switching member S2 is built), so that the battery B connected to the first connecting port 102 and the battery B connected to the second connecting port 202 are connected in parallel to supply power, and the power of the battery B connected to the first connecting port 102 and the power of the battery B connected to the second connecting port 202 together supply power to the motor module 30. After that, when the activating switch 42 is pressed, the control device 40 controls the motor module 30 to drive the transmission mechanism.

The predetermined voltage difference is a voltage difference that could allow the two batteries B to supply power, so that a problem of overcharging the battery B with a lower voltage by the battery B with a higher voltage due to an excessive voltage difference could be prevented when the two batteries B supply power at the same time. In the current embodiment, during a process of continuously detecting the first voltage V1 and the second voltage V2, the control device 40 could dynamically adjust the predetermined voltage difference, wherein the predetermined voltage difference is derived from a product of the higher voltage among the first voltage V1 and the second voltage V2 and a predetermined ratio, and the predetermined ratio is 0.1-0.3 times. In other words, when the first voltage V1 is higher than the second voltage V2, the predetermined voltage difference could be set as the first voltage V1 times the predetermined ratio, which is 0.1-0.3 times. In the current embodiment, the predetermined ratio is set as 0.25 times, In contrast, when the second voltage V2 is higher than the first voltage V1, the predetermined voltage difference could be set as the second voltage V2 times the predetermined ratio. For instance, if the first voltage is 20V and is higher than the second. voltage, the predetermined voltage difference is set as 20V times 0.25 (i.e., 5V).

### Single Battery Mode

Take the case where only the first connecting port 102 is connected to the battery B, the control device 40 controls the first switching member S1 to output the first control signal to the first control end, and does not output the second control signal to the second control end, allowing the first end to be conductively connected to the second end of the first switching member S1, so that only the battery B connected to the first connecting port 102 supplies power to the motor module 30. In contrast, when only the second connecting port 202 is connected to the battery B, the control device 40 only controls the second switching member S2 to switch on, while following process is similar to that of the aforementioned case, thus we are not going to describe in detail herein. After that, when the activating switch 42 is pressed, the control device 40 controls the motor module 30 to drive the transmission mechanism.

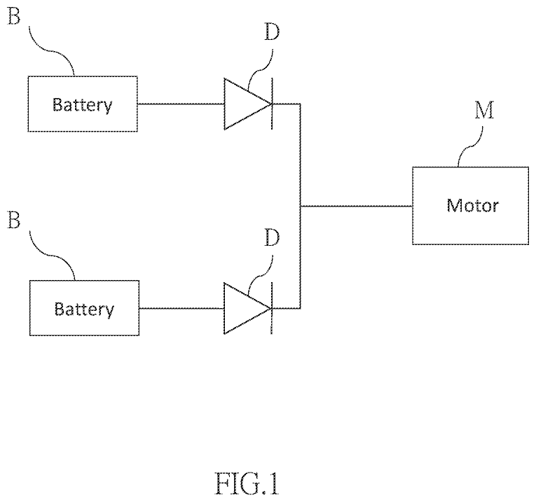

Since an on-resistance of the switching members is small, a power loss of the battery B could be smaller, and a heat energy generated when a large current passes through the switching elements could be quite small compared with the diode D of the conventional power tool shown in FIG. 1. It is worth mentioning that, the switching elements have a bidirectional conduction function, so that a back electromotive force generated by the motor module 30 could charge the battery B through the first switching member S1 or the second switching member S2, preventing the motor M from damaging due the failure of releasing energy of the back electromotive force.

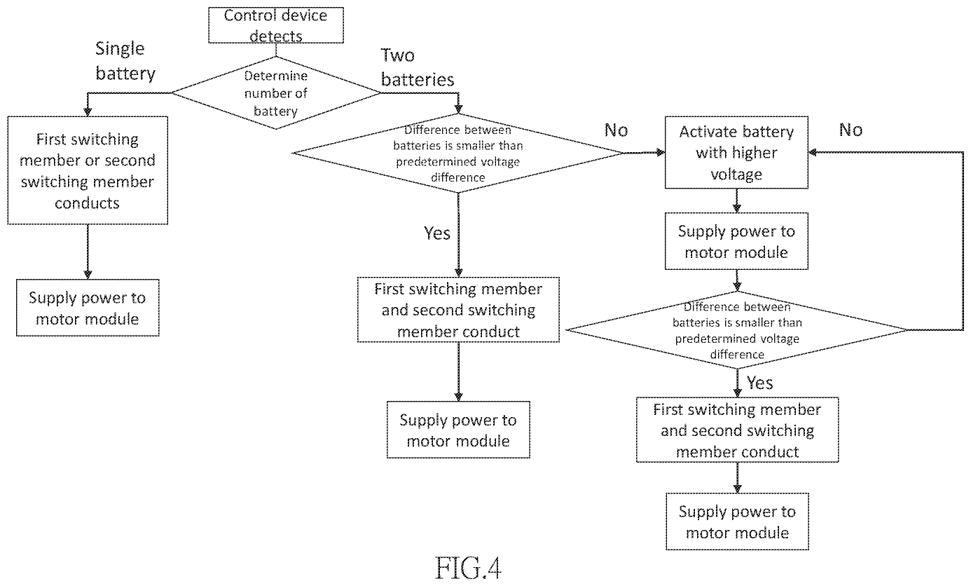

A control method according to a second embodiment of the present invention is illustrated in FIG. 4, which is based on that of the first embodiment, wherein in the dual battery mode, the battery B with a higher voltage supplies power when the difference between the two batteries B is greater than the predetermined voltage difference.

After that, when a voltage of the battery B with a higher voltage reduces to a situation that the difference between the two batteries B is smaller than or equal to the predetermined voltage difference, both the two batteries B supply power.

More specifically, when the difference between the two batteries B is greater than the predetermined voltage difference, and the first voltage V1 is greater than the second voltage V2, the control device 40 outputs the first control signal to the first control end and does not output the second control signal to the second control end to keep the first switching member S1 conduct. When the difference between the two batteries B is greater than the predetermined voltage difference, and the second voltage V2 is greater than the first voltage V1, the control device 40 outputs the second control signal to the second control end and does not output the first control signal to the first control end to keep the second switching member S2 conduct. In this way, the control device 40 could control the battery B with a higher voltage to supply power to the motor module 30.

When the battery B with a higher voltage is activated, and the activating switch 42 is pressed, the motor module 30 continuously operates to consume the power of the battery B with a higher voltage. Along with the power consumption, when the state that the voltage difference is greater than the predetermined voltage difference is changed to a state that the voltage difference is less than or equal to the predetermined voltage difference, the control device 40 outputs both the first control signal and the second control signal to allow both the first switching member S1 and the second switching member S2 to switch on, so that the battery B connected to the first connecting port 102 and the battery B connected to the second connecting port 202 could supply power to the motor module 30 at the same time.

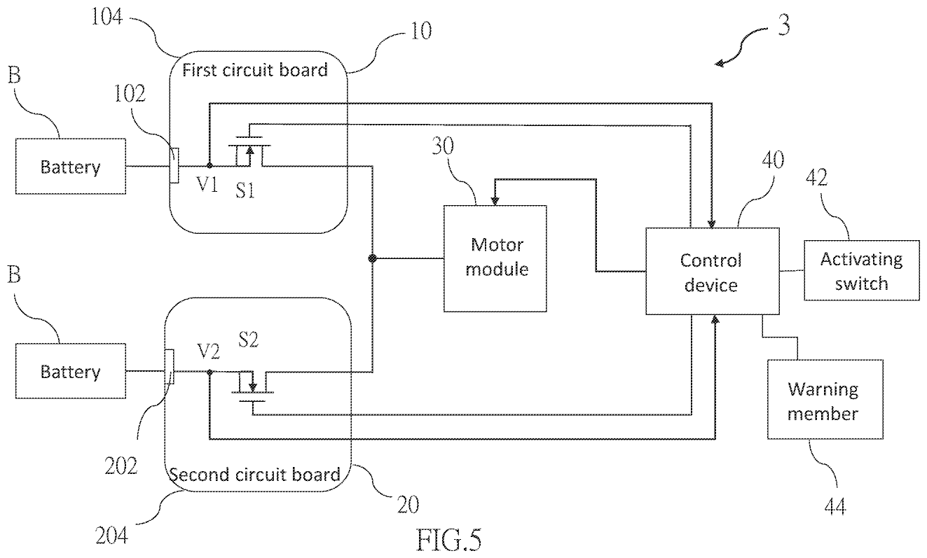

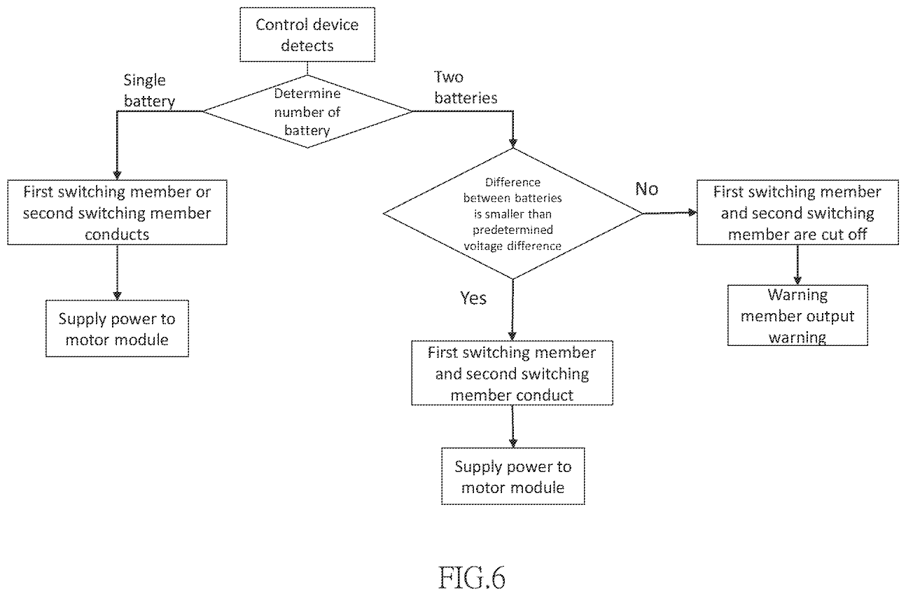

A power tool 3 according to a third embodiment of the present invention is illustrated in FIG. 5, which is based on that of the first embodiment, further including a warning member 44 electrically connected to the control device 40, wherein the warning member 44 could be, but not limited to, a LED and/or a buzzer. A control method. according to the current embodiment of the present invention is illustrated in FIG. 6, which is based on that of the first embodiment, wherein in the dual battery mode, when the control device 40 determines that the difference between the two batteries B is greater than the predetermined voltage difference, the control device 40 does not output the first control signal and the second control signal so that the first switching member S1 and the second switching member S2 are cut off, and the control device 40 controls the warning member 44 to output a warning at the same time to remind the user that the difference between the two batteries B is too large, so that the user could remove one of the batteries B first.

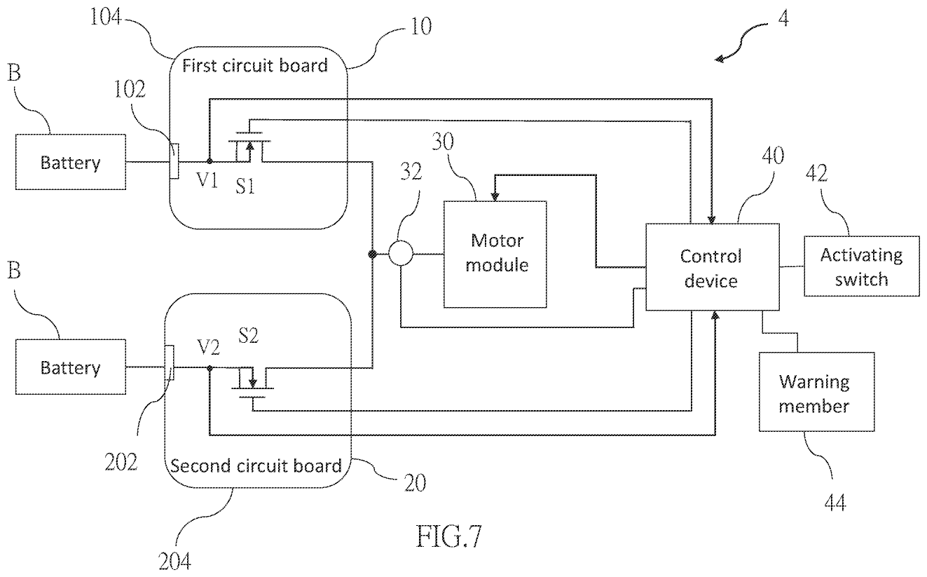

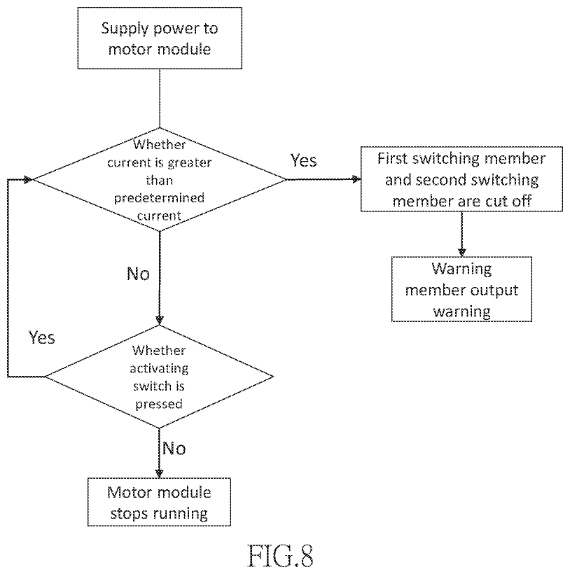

A power tool 4 according to a fourth embodiment of the present invention is illustrated in FIG. 7, which is based on that of the third embodiment, further including a current detecting member 32 electrically connected to the motor module 30 and the control device 40, wherein the current detecting member 32 is adapted to detect a current inputted to the motor module 30. A control method according to the current embodiment of the present invention is illustrated in FIG. 8, which is based on that of the third embodiment, when both the first switching member S1 and the second switching member S2 are switched on or when either the first switching member S1 or the second switching member S2 is switched on to supply power to the motor module 30, the control device 40 detects a current inputted to the motor module 30 through the current detecting member 32.

When the control device 40 determines that the current is smaller than or equal to a predetermined current, and the activating switch 42 is pressed, the control device 40 commands the motor module 30 to run, wherein during an operating process of the motor module 30, the control device 40 continuously detects the current inputted to the motor module 30 via the current detecting member 32, When the current is greater than the predetermined current, the control device 40 does not output the first control signal and the second control signal, so that the first switching member S1 and the second switching member S2 are cut off, and the control device 40 output a warning signal to the warning member 44 to make the warning member 44 output the warning, thereby preventing the battery B and/or the motor module 30 from damage. When the control device 40 determines that the activating switch 42 is not pressed, the control device 40 controls the motor module 30 to be in a state of stop running.

It is noted that, the current detecting member 32 of the current embodiment and the control method of the current embodiment could be also applied to the first embodiment and the second embodiment.

With the aforementioned design, the power tool of the present invention could obtain the electric quantity of each battery by detecting the voltage of the first connecting port and the voltage of the second connecting port through the control device. in addition, the control device further outputs the first control signal and the second control signal by determining whether the difference between the batteries is smaller than the predetermined voltage, allowing the first switching member and the second switching member to switch on to supply power to the motor module at the same time.

It must be pointed out that the embodiments described above are only sonic preferred embodiments of the present invention. All equivalent structures and methods which employ the concepts disclosed in this specification and the appended claims should fall within the scope of the present invention.

What is claimed is:

1. A power tool, comprising a first connecting port, a second connecting port, and a motor module; the power tool is characterized in that the power tool comprises:
a first switching member having a first end, a second end, and a first control end, wherein the first end is electrically connected to the first connecting port, the second end is electrically connected to the motor module, and the first control end is controllable to conduct or cut off the first end and the second end;
a second switching member having a third end, a fourth end, and a second control end, wherein the third end is electrically connected to the second connecting port, the fourth end is electrically connected to the motor module, and the second control end is controllable to conduct or cut off the third end and the fourth end; and
a control device electrically connected to the first connecting port, the second connecting port, the first control end of the first switching member, and the second control end of the second switching member, wherein when the control device determines that the first connecting port is connected to a battery and the second connecting port is connected. to a battery, the control device detects a first voltage inputted to the first connecting port and a second voltage inputted to the second connecting port; when a difference between the first voltage and the second voltage is smaller than a predetermined voltage difference, the control device outputs a first control signal to the first control end and outputs a second control signal to the second control end, thereby building a conduction between the first end and the second end and building a conduction between the third end and the fourth end, allowing both a power of the battery connected to the first connecting port and a power of the battery connected to the second connecting port to supply to the motor module.

2. The power tool as claimed in claim 1, wherein when the control device determines that only the first connecting port among the first connecting port and the second connecting port is connected to the battery, the control device outputs the first control signal to the first control end, thereby building the conduction between the first end and the second end, allowing the power of the battery connected to the first connecting port to supply alone to the motor module.

3. The power tool as claimed in claim f, wherein when the first voltage is greater than the second voltage and the difference between the first voltage and the second voltage is greater than the predetermined voltage difference, the control device outputs the first control signal to the first control end, and does not output the second control signal to the second control end; when the second voltage is greater than the first voltage and the difference between the first voltage and the second voltage is greater than the predetermined voltage difference, the control device outputs the second control signal to the second control end, and does not output the first control signal to the first control end.

4. The power tool as claimed in claim 3, wherein when the difference between the first voltage and the second voltage changes from greater than the predetermined voltage difference to less than the predetermined voltage difference, the control device outputs the first control signal to the first control end and outputs the second control signal to the second control end.

5. The power tool as claimed in claim 1, wherein when the difference between the first voltage and the second voltage is greater than the predetermined voltage difference, the control device does not output the first control signal and the second control signal, so that both the first switching member and the second switching member switch off.

6. The power tool as claimed in claim 1, further comprising a warning member electrically connected to the control device, wherein when the difference between the first voltage and the second voltage is greater than the predetermined voltage difference, the control device controls the warning member to output a warning,

7. The power tool as claimed in claim 1, further comprising a current detecting member electrically connected to the motor module and the control device, wherein the current detecting member is adapted to detect a current inputted to the motor module;
when the current detected by the current detecting member is greater than a predetermined current, the control device does not output the first control signal and the second control signal, so that both the first switching member and the second switching member switch off.

8. The power tool as claimed in claim 7, wherein when the current detected by the current detecting member is greater than the predetermined current, the control device controls the warning member to output a warning.

9. The power tool as claimed in claim 1, wherein the control device determines that the first connecting port is connected to the battery when the control device detects that the first connecting port has the first voltage, while the control device determines that the second connecting port is connected to the battery when the control device detects that the second connecting port has the second voltage.

10. The power tool as claimed in claim 1, further comprising a first circuit board and a second circuit board, wherein the first connecting port and the first s witching member are disposed on the first circuit board, and the second connecting port and the second switching member are disposed on the second circuit board.

11. The power tool as claimed in claim 1, wherein the predetermined voltage difference is derived from a product of either the first voltage or the second voltage that has a higher voltage and a predetermined ratio; the predetermined ratio is 0.1-0.3 times.

12. A method of controlling a power tool, wherein the power tool comprises a first connecting port, a second connecting port, a first switching member, a second switching member, a motor module, and a control device; the first switching member has a first end, a second end, and a first control end, wherein the first end is electrically connected to the first connecting port, the second end is electrically connected to the motor module, and the second switching member has a third end, a fourth end, and a second control end; the third. end is electrically connected to the second connecting port, the fourth end is electrically connected to the motor module, and the control device is electrically connected to the first connecting port, the second connecting port, the first control end of the first switching member, and the second control end of the second switching member; the method comprises steps of:
taking following steps when the control device determines that the first connecting port is connected to a battery and the second connecting port s connected to a battery;
A1. detecting a first voltage inputted to the first connecting port and a second voltage inputted to the second connecting port through the control device;
A2. outputting a first control signal to the first control end and outputting a second control signal to the second control end through the control device when the control device determines that a difference between the first voltage and the second voltage is smaller than a predetermined voltage difference, thereby building a conduction between the first end and the second end and building a conduction between the third end and the fourth end, allowing both a power of the battery connected to the first connecting port and a power of the battery connected to the second connecting port to be supplied to the motor module.

13. The method as claimed in claim 12, further comprising following steps:
outputting the first control signal to the first control end through the control device when the control device determines that only the first connecting port among the first connecting port and the second connecting port is connected to the battery, thereby building the conduction between the first end and the second end, allowing the power of the battery connected to the first connecting port to supply alone to the motor module.

14. The method as claimed in claim 12, wherein step A2 further comprising steps of outputting the first control signal to the first control end and not outputting the second. control signal to the second control end when the control device determines that the first voltage is greater than the second voltage and the difference between the first voltage and the second voltage is greater than the predetermined voltage difference; outputting the second control signal to the second control end and not outputting the first control signal to the first control end when the control device determines that the second voltage is greater than the first voltage and the difference between the first voltage and the second voltage is greater than the predetermined voltage difference.

15. The method as claimed in claim 12, wherein step A2 further comprising a step of outputting the first control signal to the first control end and outputting the second control signal to the second control end when the control device determines that the difference between the first voltage and the second voltage changes from greater than the predetermined voltage difference to less than the predetermined voltage difference.

16. The method as claimed in claim 12, wherein step A2 further comprising a step of not outputting the first control signal to the first control end and not outputting the second control signal to the second control end through the control device when the control device determines that the difference between the first voltage and the second voltage is greater than the predetermined voltage difference, so that both the first switching member and the second switching member switch off

17. The method as claimed in claim 12, wherein the power tool further comprises a warning member electrically connected to the control device; the control device controls the warning member to output a warming when the difference between the first voltage and the second voltage is greater than the predetermined voltage difference.

18. The method as claimed in claim 12, wherein the power tool further comprises a current detecting member electrically connected to the motor module and the control device; the current detecting member is adapted to detect a current inputted to the motor module: the control method further comprising a step of not outputting the first control signal to the first control end and not outputting the second control signal to the second. control end through the control device when the control device determines that the current detected by the current detecting member is greater than a predetermined current, so that both the first switching member and the second switching member switch off.

19. The method as claimed in claim 18, further comprising a step of outputting a warning signal through the control device when the current detected by the current detecting member is greater than the predetermined current.

20. The method as claimed in claim 19, wherein the predetermined voltage difference is derived from a product of either the first voltage or the second voltage that has a higher voltage and a predetermined ratio; the predetermined ratio is 0.1-0.3 times.
